(19) United States
(12) Patent Application Publication
(10) Pub. No.: US 2010/0057647 A1
(43) Pub. Date: Mar. 4, 2010

(54) ACCOMMODATING LEARNED CLAUSES IN RECONFIGURABLE HARDWARE ACCELERATOR FOR BOOLEAN SATISFIABILITY SOLVER

(75) Inventors: John Davis, San Francisco, CA (US); Zhangxi Tan, Albany, CA (US); Fang Yu, Sunnyvale, CA (US); Lintao Zhang, Sunnyvale, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/203,948

(22) Filed: Sep. 4, 2008

(51) Int. Cl. G06F 15/18; G06N 5/04

(52) U.S. Cl. 706/12

(57) ABSTRACT

A hardware accelerator is provided for Boolean constraint propagation (BCP) using field-programmable gate arrays (FPGAs) for use in solving the Boolean satisfiability problem (SAT). An inference engine may perform implications. Learned clauses may be generated during conflict analysis. Operations pertaining to learned clauses may include clause insertion and clause deletion (e.g., by invalidation) from a learned clause inference engine, and “garbage collection” in which unused or invalidated clauses may be removed from an inference engine.

### BACKGROUND

The Boolean satisfiability problem (SAT) is a decision problem whose instance is a Boolean expression written using only AND, OR, NOT, variables, and parentheses. A formula of propositional logic is said to be satisfiable if logical values can be assigned to its variables in a way that makes the formula true.

Hardware assisted SAT solving has attracted much research in recent years. Conventional hardware solvers are slow and capacity limited, rendering them either obsolete and/or severely constrained. Additionally, conventional hardware solvers do not accommodate learned clauses.

### SUMMARY

A hardware accelerator is provided for Boolean constraint propagation (BCP) using field-programmable gate arrays (FPGAs) for use in solving the Boolean satisfiability problem (SAT). An inference engine may perform implications. Block RAM (BRAM) may be used to store SAT instance information. SAT instances may be partitioned into sets of clauses that can be processed by multiple inference engines in parallel.

In an implementation, learned clauses may be generated and may be dynamically added and removed from inference engines. Inference engines may be partitioned such that at least one of the inference engines is dedicated to original (non-learned) clauses and at least one of the inference engines is dedicated to learned clauses.

In an implementation, a learned clause may be inserted into an inference engine that has space available for the insertion and that does not contain any of the literals in the learned clause.

In an implementation, a learned clause may be deleted (e.g., by invalidation) from an inference engine. Unused or invalidated clauses may be removed from an inference engine using “garbage collection”.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of an implementation of a hardware SAT accelerator system;

FIG. 2 is a block diagram of an implementation of a FPGA BCP co-processor;

FIG. 3 is an operational flow of an implementation of a method for clause partitioning;

FIG. 4 is a diagram of an implementation of an implication process that may be used by an inference engine;

FIG. 5 is a diagram of an example clause index tree;

FIG. 6 is a block diagram of another implementation of a hardware SAT accelerator system;

FIG. 7 is an operational flow of an implementation of a method for inserting a clause;

FIG. 8 is a diagram of an implementation of aspects of a learned clause system architecture;

FIG. 9 is an operational flow of an implementation of a method for deleting a clause and garbage collection; and

FIG. 10 shows an exemplary computing environment.

### DETAILED DESCRIPTION

A field-programmable gate array (FPGA) based accelerator may be used to solve Boolean satisfiability problems (SAT). The SAT solver is accelerated by moving Boolean constraint propagation (BCP) and unit implication functionality to the FPGA. An application-specific architecture may be used instead of an instance-specific one to avoid time consuming FPGA synthesis for each SAT instance. SAT instances may be loaded into an application-specific FPGA BCP co-processor. Block random access memory (block RAM or BRAM) in the FPGA may be used to store instance-specific data. This reduces the instance loading overhead and simplifies the design of the interface with the host CPU.

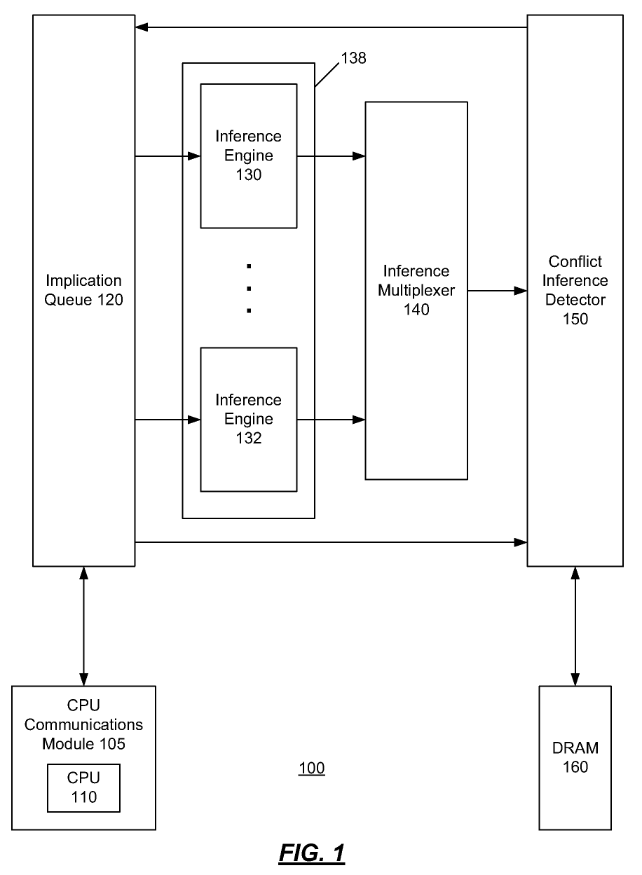

FIG. 1 is a block diagram of an implementation of a hardware SAT accelerator system 100. An example hardware accelerator may be a FPGA Boolean constraint propagation accelerator. A CPU communications module 105 receives branch decisions from a CPU 110, and may return inference results back to the CPU 110.

One or more implication inference engines 130, 132 (referred to herein as inference engines) are provided in parallel as part of an inference module 138. Each inference engine 130, 132 may store a set of clauses. Clauses of the SAT formula may be partitioned and stored in multiple parallel inference engines. Given a decision, inferences may be performed in parallel. Although only two inference engines 130, 132 are shown, it is contemplated that any number of inference engines may be implemented in a hardware SAT accelerator system 100.

An implication queue 120 comprising storage such as a first input first output (FIFO) buffer is provided. Decisions from the CPU 110 and implications derived from one or more of the inference engines 130, 132 may be queued in the implication queue 120 and sent to the one or more of the inference engines 130, 132. The implication queue 120 may store the implications performed and send the implications to the CPU 110.

An inference multiplexer 140 serializes inference results from the inference engines 130, 132. The inference multiplexer 140 also may serialize the data communications between the inference engines 130, 132 and a conflict inference detector 150. The conflict inference detector 150 may store global variable values and may detect conflict inference results generated by the inference engines 130, 132. In an implementation, the conflict inference detector may comprise a global status table in on-chip RAM that tracks variable status, and a local undo module that, when a conflict occurs, un-assigns variables (e.g., still in a buffer) and reports the results (e.g., at the same time) to the CPU 110.

It is contemplated that the choices of heuristics such as branching order, restarting policy, and learning and backtracking may be implemented in software, e.g., in the CPU 110.

In an implementation, the accelerator may be partitioned across multiple FPGAs, multiple application specific integrated circuits (ASICs), a combination of one or more FPGAs and ASICS, or may comprise a central controller chip comprising the conflict inference detector 150, the implication queue 120, and the CPU communications module 105 and a plurality of chips comprising the inference engines 130, 132 and the inference multiplexer 140.

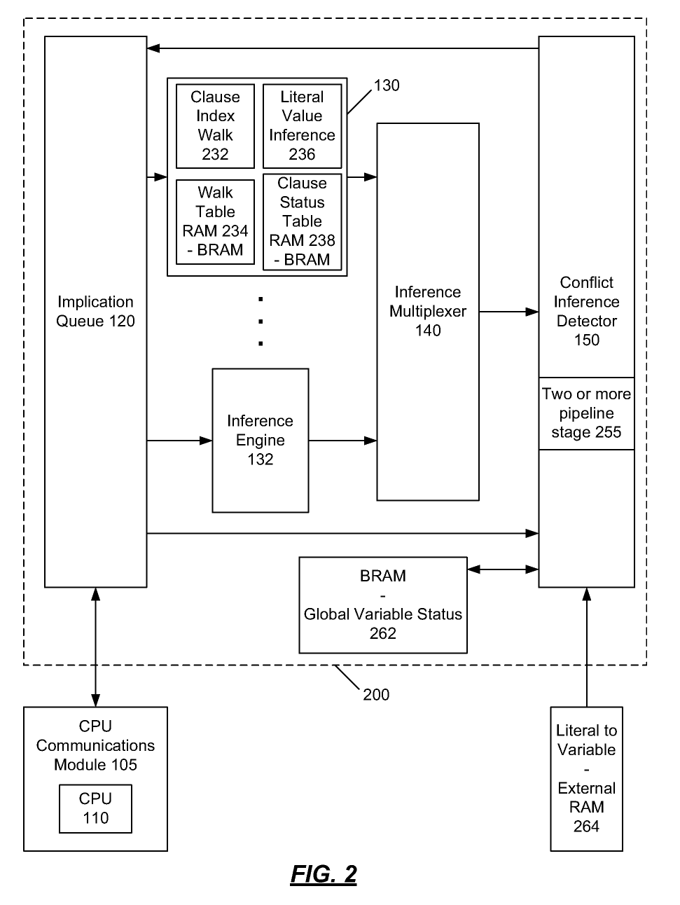

FIG. 2 is a block diagram of an implementation of a FPGA BCP co-processor 200. The implication queue 120, the inference engines 130, 132, the inference multiplexer 140, and the conflict inference detector 150 may be implemented using one or more FPGAs. An FPGA is a semiconductor device containing programmable logic components called “logic blocks” and programmable interconnects. Logic blocks can be programmed to perform the function of basic logic gates such as AND and XOR, or more complex combinational functions such as decoders or mathematical functions. In most FPGAs, the logic blocks also include memory elements, which may be flip-flops or more complete blocks of memory.

Each inference engine may comprise a clause index walk 232, a walk table 234, a literal value inference 236, and a clause status table 238, described further below. The conflict inference detector 150 may comprise a two or more pipeline stage 255 for communicating with the implication queue 150 and memory such as global variable status BRAM 262 and literal to variable external mapping RAM 264.

Given a new variable assignment, the SAT solver may infer the implications caused by the new assignment and current variable assignments. To accomplish this, the clause information may be stored. Each FPGA has block RAM (BRAM) 262 which is distributed around the FPGA with configurable logics (e.g., lookup tables or LUTs). BRAM 262 may be used to store clause information, thus avoiding re-synthesis of the logic in the FPGA. In this manner, in an implementation, a new instance of the Boolean satisfiability formula may be inserted into memories on the FPGA without invoking an FPGA re-synthesizing process. Multiple BRAM blocks may be accessed at the same time to provide the bandwidth and parallelism. Moreover, BRAM 262 can be loaded on the fly which may be useful for aspects of learning such as dynamic clause addition and deletion. In an implementation, BRAM 262 in the FPGA may be dual ported.

Clauses may be partitioned into non-overlapping groups so that each literal only occurs at most p times in each group, where p may be restricted to be a small number, e.g., one or two. In an implementation, the clauses may be partitioned by the CPU 110. Each group of clauses may be processed by an inference engine. Thus, by limiting p, multiple inference engines (e.g., inference engines 130, 132) may process literal assignments in parallel rather than serially. Given a newly assigned variable, each inference engine may work on at most p related clauses, a process that takes a fixed number of cycles. Enough BRAM may be allocated for each inference engine to store c clauses, with c being a fixed number for all engines (e.g., 1024). In this way, an array of inference engines may run in parallel. By partitioning clauses into groups, the number of inference engines can be significantly smaller than the number of clauses, more efficiently utilizing FPGA resources.

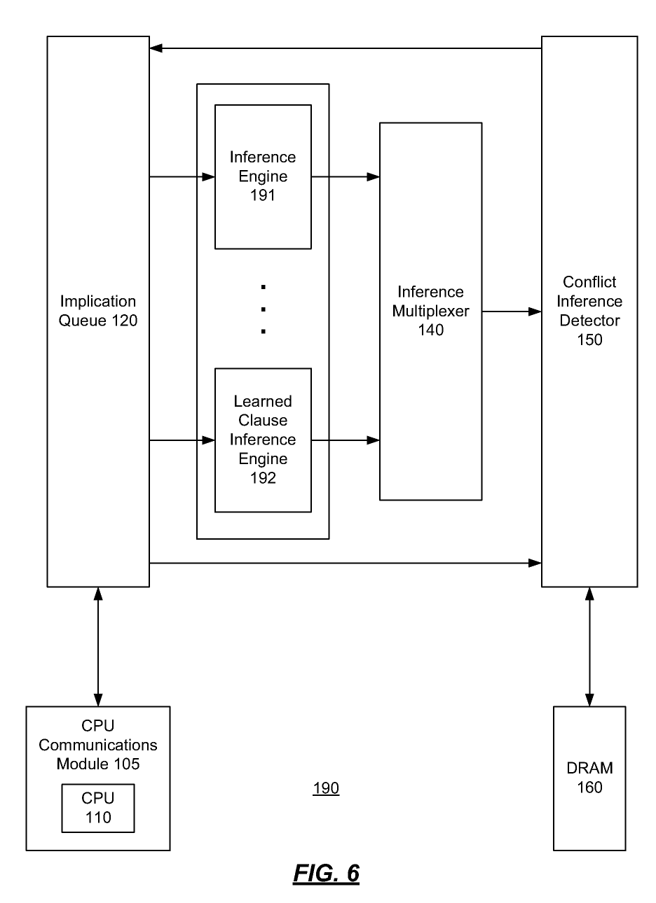

In an implementation, p may be larger than one because slightly larger p can help reduce the number of inference engines that are used. This may be helpful for long clauses such as learned clauses (described further herein with respect to FIGS. 6 through 9, for example) because they share variables with many other clauses. It is noted that p and c may be adjusted to optimize the number of inference engines and the memory utilization within the inference engine. An implementation of a partitioning technique is described further herein.

Regarding a clause partition for inference engines, as mentioned previously, the number of clauses associated with any inference engine may be limited to be at most c clauses, and the maximum number of occurrences of any variable in an inference engine may be limited to be p. A technique for partitioning a SAT instance into sets of clauses that satisfy these restrictions is described.

If each literal is restricted to be associated with at most one clause (p=1) in each group, and an unlimited group size (e.g., c=∞) is permitted, the problem is similar to a graph coloring problem. Each vertex in the graph represents a clause. An edge between two vertices denotes that these two clauses share a common literal. The graph coloring process ensures that no two adjacent vertices have the same color. This process is equivalent to dividing the clauses into groups with each color denoting a group and no two clauses in a group sharing any literal. Therefore, graph coloring techniques may be used to solve a relaxed partitioning problem (c=∞ and p=1).

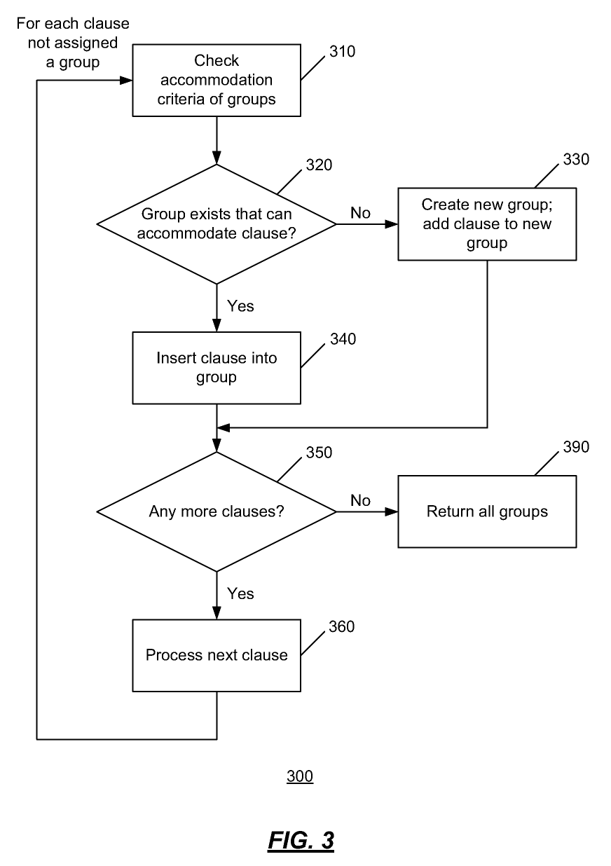

The graph coloring problem is a well known NP complete problem and has been extensively studied. To reduce the complexity, a greedy algorithm may be used to partition the clauses. The clauses may be partitioned in multiple inference engines. Pseudo-code is provided below and FIG. 3 is an operational flow of an implementation of a method 300 for clause partitioning. For the pseudo-code, the input comprises a clauses list C, and the maximum number of clauses associated with one variable is p, and the output comprises groups of clauses, with each group fitting into one inference engine.

1 Begin
2 Groups G = 0
3 For each clause Cᵢ that has not been assigned a group yet
4 For each group Gᵢ in G
5 For each variable Vⱼ in Cᵢ
6 If Vⱼ has p related clauses in group Gᵢ already
7 pass to next group Gᵢ+1 (Goto line 4);
8 End for
9 assign Cᵢ to the group Gᵢ;
10 pass to next clause (Goto line 3);
11 End for
12 Create a new group G_{new} and add it to G;
13 Add clause Cᵢ to group G_{new};
14 End for
15 Return all groups in G
16 End

An example greedy clause partitioning technique, described with respect to FIG. 3, begins with zero groups. The method loops through the clauses that have not been assigned a group, and for each clause, inserts the clause into the first (or in an implementation, the best) group Gᵢ that can accommodate it. At operation 310, the accommodation criteria are checked (e.g., lines 5-8 of the pseudo-code). For each variable in clause Cᵢ, there should be no more than p-1 related clauses in group Gᵢ.

If a group Gᵢ exists that can accommodate this clause as determined at operation 320, the clause is inserted into the group at operation 340. Otherwise, at operation 330, a new group (line 12) is created and the clause is added to the new group (line 13).

It may be determined at operation 350 whether any more clauses are to be processed. If so, the next clause may be processed at operation 360, with processing continuing at operation 310. If there are no more clauses to be processed, all groups in G may be returned at operation 390. This technique is polynomial with respect to the size of the input.

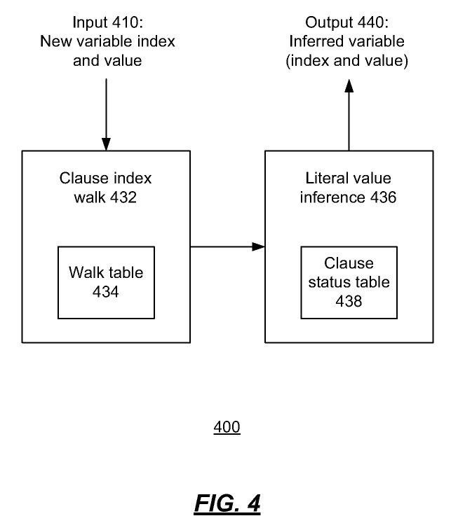

Each inference engine may use a two part operation to process new variable assignments and produce any new implications, as described with respect to FIG. 4. FIG. 4 is a diagram of an implementation of an implication process 400 that may be used by an inference engine. At 432, using a new variable index and value as an input 410, the inference engine (e.g., the inference engine 130) may determine whether the assigned variable is related to any clauses stored in the inference engine, and if so, may identify these clauses. A walk table 434 may be used. At 436, the inference engine may examine these clauses to determine whether they imply a new variable. A clause status table 438 may be used. An output 440 may comprise an inferred variable comprising an index and value.

Regarding literal occurrence lookup, at 432, given a newly assigned variable as input 410, the inference engine may locate the clause associated with the variable that can generate implications. In a software SAT solver, this can be implemented by associating each variable with an array of its occurrence (an occurrence list). A more efficient implementation may only store the watched clauses in each array (a watched list). This optimization reduces the number of clauses to be examined, but does not reduce the total number of arrays, which is proportional to the number of variables.

In an implementation, given an inference engine, each variable has at most p occurrences and most variables will have no occurrence at all. Storing an entry for each variable in every inference engine is an inefficient use of space since SAT benchmarks often contain thousands of variables. A possible solution for this problem is to use a content addressable memory (CAM), the hardware equivalent of a hash table, comprised within an FPGA. Alternatively, a tree walk technique may be implemented.

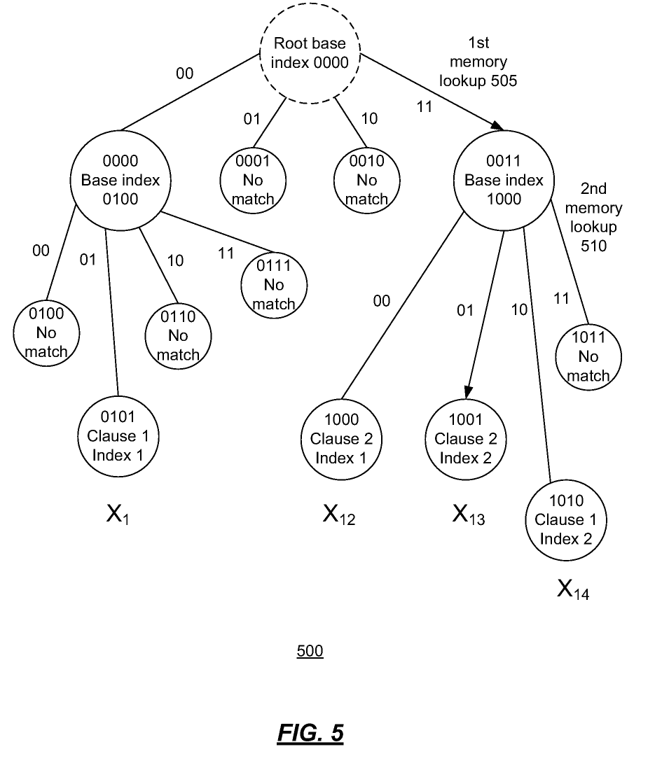

FIG. 5 is a diagram of an example clause index tree 500 and may be used to describe a clause index tree walk in the inference engine. A tree may be stored in the walk table 434, such as a tree walk table, e.g. in an on-chip BRAM 234 local to the inference engine 130. Suppose the variable index has a width of k (so that the accelerator can handle 2^{k} variables) and every non-leaf tree node has 2^{m} child nodes, then the tree will be k/m deep. Here both k and m are configurable. Given a non-leaf node, the address of its leftmost child in the tree walk table is called the base index of this tree node. The rest of the children are stored sequentially in the table following the leftmost child. Therefore, to locate the ith child, the index can be calculated by adding i to the base index. If a child is not associated with any clauses, a no-match (−1) tag may be stored in the entry. If for a node, all of its 2^{m} children have no-match, the tree node is not expanded and a no-match tag is stored in the node itself. The entry of a leaf node stores the clause ID where the variable occurs, as well as the literal index in the clause that corresponds to the variable.

FIG. 5 provides an example with a literal index size k=4 and a tree branch width m=2. There are two clauses (x₁ v x₁₄) and (x₁₂ v x₁₃), where variable x₁'s index is 0001, x₁₂'s index is 1100, x₁₃'s index is 1101, and x₁₄'s index is 1110. Suppose the newly assigned variable is 1101.

The arrows in the tree 500 represent the two memory lookups 505, 510 used to locate the clauses associated with the decision variable 1101 (x₁₃). The base index of the root node is 0000 and the first two bits of the input are 11. The table index is the sum of two: 0000+11=0011. Using this table index, the first memory lookup 505 is conducted by checking the 0011 entry of the table. This entry shows that the next lookup 510 is an internal tree node with the base index 1000. Following this base index, adding it to the next two bits of the input 01, the leaf node 1000+01=1001 is reached. This leaf node stores the variable association information; in this case, the variable is associated with the second variable of clause two.

Table 1 shows a clause index walk table for internal tree nodes, and illustrates the tree structure mapping to a table.

TABLE 1

| Table Index | Base Index |
|---|---|
| 0000 | 0100 |
| 0001 | −1 (No match) |
| 0010 | −1 (No match) |
| 0011 | 1000 |
| 0100-1011 | Leaf nodes |

Note the last m bits of the base index are all zeros. This is because each internal node has exactly 2^{m} children. Even if a child is not associated with any related clauses, the child's index is still stored, using a no-match tag. In such an implementation, the addition operation is not necessary. The top k-m bits of the base index may be used and concatenated with the input to obtain the table index, removing the need for a hardware adder and also saving one cycle.

Table 2 shows a clause index walk table for leaf tree nodes.

TABLE 2

| Table | |
|---|---|
| Index | Information stored at leaf nodes |
| 0100 | −1 |
| 0101 | CID 1, PID 1, positive |
| 0110 | −1 |
| 0111 | −1 |
| 1000 | CID 2, PID 1, negative |
| 1001 | CID 2, PID 2, positive |
| 1010 | CID 1, PID 2, positive |
| 1011 | −1 |

For a leaf node, the table stores the related clause information. It contains the clause ID (CID), the position in the clause (PID), and its sign (whether it is a positive or negative literal in the clause). This information may be used by the literal value inference module 436 for generating new inferences. Note that the CID does not need to be globally unique, as a locally unique ID is sufficient to distinguish different clauses associated with one inference engine.

It is contemplated that the mapping between a local CID to a global CID may be stored in dynamic random access memory (DRAM) and maintained by the conflict inference detector 150 of the system 100.

If p>1, each variable can be associated with p clauses per inference engine. They can be stored sequentially at the leaf nodes. The inference engine can process them sequentially with one implication module. If hardware resources permit, it is also possible to process them in parallel because they are associated with different clauses.

To store the tree in on-chip memory, the entire tree may be put into BRAM. In an implementation, an inference engine uses four cycles to identify the related clause in the BRAM. Using a single port of the BRAM, inference engines can service a new lookup every four cycles.

In an implementation, distributed RAM may be used to store the first two levels of the tree. Similar to BRAM, distributed RAM is also dynamically readable and writable, but with much smaller total capacity. Since the top two levels of tree are very small, they can fit into distributed RAM. The rest of the tree may be stored in BRAM. By doing this, the four cycle pipeline stage may be broken into two pipeline stages with two cycles each, thus improving inference engine throughput to lookups every two cycles.

Regarding inference generation, at 436, after finding a clause to examine, the clause that contains the newly assigned variable may be examined to see whether it infers any new implications. The literals' values in each clause may be stored in a separate BRAM called the clause status table 438.

In an implementation, an inference engine in the inference module 138 takes the output of the previous stage as inputs, which includes the CID, PID in addition to the variable's newly assigned value. With this information, it may examine the clause status table, update its status, and output possible implications in two cycles as output 440.

By using parallelism in hardware, it has been determined that the inference engines can infer implications in 6 to 17 clock cycles for a new variable assignment in an implementation. Simulation shows that the BCP accelerator is approximately 3 to 40 times faster than a conventional software based approach for BCP without learned clauses.

Learning may be a feature of SAT solvers and may increase the speed of solving SAT instances. Learned clauses may be generated during conflict analysis and may be added to storage or an inference engine for use in analyzing and pruning the results of a search.

Clauses may be dynamically added and removed from inference engines to enable learning. In an implementation, the inference engines in the inference module 138 may be partitioned such that at least one of the inference engines is dedicated to original (non-learned) clauses and at least one of the inference engines is dedicated to learned clauses. For example, one or more of the inference engines may be a learned clause inference engine, and learned clauses may be dynamically inserted and deleted from the learned clause inference engine.

FIG. 6 is a block diagram of another implementation of a hardware SAT accelerator system 190. The implementation shown in FIG. 6 is similar to that shown in FIG. 1 and may have elements or components that are similar. These similar elements or components are labeled identically and their descriptions are omitted for brevity.

The hardware SAT accelerator system 190 comprises an inference engine 191 and a learned clause inference engine 192. The inference engine 191 may be used for original clauses and may contain static content for a given SAT instance, similar to the inference engine 130 described above for example. The learned clause inference engine 192 has dynamic content. The system 190 may comprise more than one inference engine for original clauses and/or may comprise more than one learned clause inference engine.

Alternatively, one or more inference engines, such as the inference engine 191 and/or the inference engine 192, may store static content and dynamic content. In an implementation, learned clause inference engines may be spread over or distributed among multiple FPGAs. In such a case, a control FPGA may communicate with the FPGAs that contain the clause inference engines.

Operations pertaining to learned clauses may include clause insertion, clause deletion (e.g., by invalidation), and “garbage collection” in which unused or invalidated clauses may be removed from an inference engine.

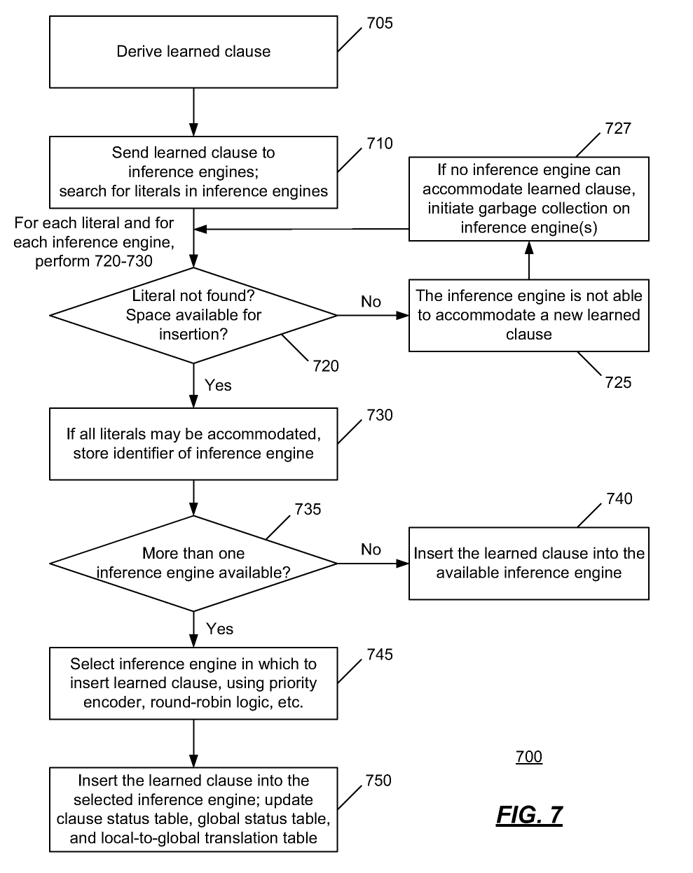

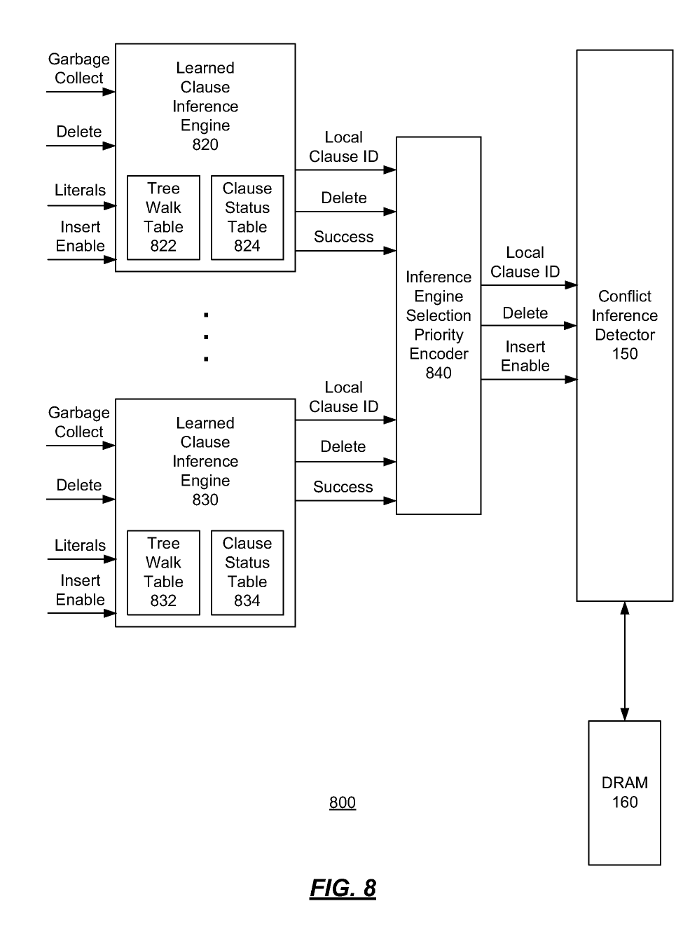

FIG. 7 is an operational flow of an implementation of a method 700 for inserting a clause, and FIG. 8 is a diagram of an implementation of aspects of a learned clause system architecture 800. The implementation shown in FIG. 8 may have elements or components that are similar to those described above. These similar elements or components are labeled identically and their descriptions are omitted for brevity.

At 705, a learned clause may be derived, e.g., using any known conflict analysis process. An inference engine, such as a learned clause inference engine 820 or 830 in the architecture 800, may be determined that it can accommodate the learned clause. It would be time consuming to use software to examine the inference engines (e.g., hundreds of inference engines although only the learned clause inference engines 820, 830 are shown in FIG. 8) in the system to determine which, if any, of the inference engines may accommodate the learned clause. Instead, the parallelism and the tree walk techniques described above with respect to hardware may be used to determine the inference engine(s) that may accommodate the learned clause.

At 710, the learned clause may be sent to the inference engines, such as the learned clause inference engines 820, 830. The tree walk tables 822, 832, respectively, pertaining to the learned clause inference engines 820, 830 may be searched for the literals of the learned clause to determine whether a literal from the learned clause already occurs in a clause of the associated inference engine. The search in each inference engine 820, 830 may be performed sequentially using a second memory port of the BRAM, for example.

In an implementation, if there are m literals in the learned clause, for each literal, the tree associated with each inference engine may be walked to determine whether or not the literal is found at a tree leaf node (e.g., whether or not a no-match tag is found) and if there is space in the tree leaf node for insertion of the learned clause, at 720. If the literal is not already in a tree leaf node and if there is space, the inference engine may accommodate this literal. This checking process may use four cycles per literal to traverse the entire tree or 4m cycles for one learned clause with m literals. The learned clause inference engines may perform the checking in parallel, and because the checking uses the second memory port in an implementation, it may be performed without disrupting an implication process described above. If all m literals can be accommodated, an identifier of the inference engine may be stored in storage at 730.

For each inference engine, if at least one of the literals is found or space is not available for insertion, then the inference engine is determined at 725 to not be able to accommodate a new learned clause.

If no inference engine indicates that the learned clause may be inserted, garbage collection may be initiated at 727. Garbage collection is described further with respect to the method 900, for example. After garbage collection has been performed on at least one of the inference engines, processing may continue at 720.

In an implementation, more than one inference engine may be able to accommodate the learned clause. At 735, it may be determined if more than one inference engine may be able to accommodate the learned clause. If not (i.e., if only one inference engine has been determined that may accommodate the learned clause), then the learned clause may be inserted into the available inference engine at 740.

Otherwise, a priority encoder, such as an inference engine selection priority encoder 840, or round-robin logic or any other selection heuristic may be used at 745 to select the inference engine for learned clause insertion. At 750, the selected inference engine may store the learned clause (i.e., the learned clause may be inserted into the selected inference engine). In an implementation, the selected inference engine may receive an insertion enable signal and may insert the literals into its associated tree walk table. Each inference engine may keep a free-index pointer to indicate the starting point of un-used entries in its tree walk table. The literals may be inserted sequentially by traversing the tree m times again. Such a technique may use a tree traversal and update to nodes at various levels in the tree. If there is no match (e.g., a no-match tag is encountered), a subtree may be created by accessing and updating the free-index pointer to insert new nodes. Another tree walk table operation may update the tree leaf node with the CID, the PID, and the sign of the literal.

The clause status table associated with the selected inference engine (such as the clause status table 824 associated with the learned clause inference engine 820 or the clause status table 834 associated with the learned clause inference engine 830, for example) may be updated accordingly at 750 (e.g., the learned clause may be added to a learned clause status table). A global status table and a local-to-global translation table (e.g., mapping from a learned clause identifier and position to a global status table) in the conflict inference detector 150 may also be updated at 750. These updates may be performed after the learned clause inference engine has been selected at 745 or may be performed after 740 if there is only one available inference engine in which to insert the learned clause. It should be noted that these updates can be done in parallel with the actual insertion into the tree walk table because the information is known at that point. Moreover, the status of the clause insertion (e.g., that it was successful) and the identifier of the inference engine that stores the learned clause may be stored and subsequently used in clause deletion and garbage collection, described further herein.

Learned clauses may be long, and an inference engine may have a fixed maximum length for clauses (e.g., a multiple of the size of a BRAM word). Clauses longer than the maximum length may not be added to an inference engine directly. A technique for adding a learned clause having a length exceeding the maximum involves breaking the clause into multiple shorter clauses by introducing new variables. For example, the clause (x₁ [symbol] x₂ . . . [symbol] y₁ [symbol] y₂ . . . ) is equi-satisfiable to the clauses (z [symbol] x₁ [symbol] x₂ . . . ) [symbol] ( [symbol] z [symbol] y₁ [symbol] y₂ . . . ) where z is a new variable. The transformed formula is logically equivalent (modulo existentially quantified bridging variables) to the original one. A drawback is that the number of literals is increased, which takes hardware resources. Extra implications may be used to pass through the bridging variable, which may slow down the solver.

Another technique for adding a learned clause having a length exceeding the maximum may be to abbreviate the learned clause. When a learned clause is generated from conflict analysis, it may be an asserting clause and may contain many false literals assigned at lower decision levels. At higher decision levels, these literals can be omitted because their values do not change. Thus, lower decision level literals may be thrown away and the clause may be marked as valid only after a certain decision level. To maintain the correctness of the solver, the clause may be invalidated when the solver backtracks to an earlier decision level and as a result, the clause may be garbage collected. This technique stores a smaller number of literals for each clause. The technique may invalidate clauses dynamically, thus complicating the solver logic. Moreover, some learned clauses may be deleted after deep backtracks and restarts, thus reducing the possibility of future pruning of the search space.

The learned clause techniques described herein may be orthogonal to the normal BCP operation. Because the learned clauses may be separated from the other clauses, the other clause processes may keep running while the learned clauses processes are running.

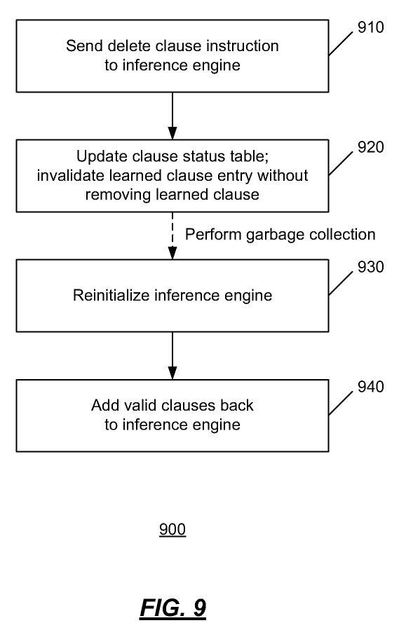

FIG. 9 is an operational flow of an implementation of a method 900 for deleting a clause and garbage collection. When a learned clause is to be deleted from an inference engine (e.g., pursuant to a user request, because the inference engine is freeing up storage, etc.), a delete clause instruction may be sent to the inference engine storing the learned clause at 910. A learned clause to inference engine mapping may be retrieved from storage to determine which inference engine stores the learned clause that is selected for deletion.

The inference engine that stores the learned clause may update the clause status table and invalidate the learned clause entry therein at 920 by adding a tag to prevent future implications from being generated by the learned clause. In an implementation, the learned clause may be marked (e.g., by adding a bit to the learned clause in the clause status table) to indicate that it may not generate implications. Even though the learned clause information may remain in the tree walk table, subsequent lookups in the tree walk table will result in no inferences. In this manner, the learned clause may be invalidated or otherwise disabled, without removing the learned clause from the inference engine.

Even though invalidated learned clauses will not generate implications, they still occupy space in the BRAM. Garbage collection may be used to remove invalidated learned clauses from inference engines. In an implementation, garbage collection may be a software directed task that can be triggered by a threshold value of invalidated learned clauses or the inability to insert a new learned clause into the tree walk table of an inference engine (e.g., at operation 725). The garbage collection operation may be controlled at the granularity of a single inference engine. Thus, implications from the other inference engines can be generated while one or more inference engines are being garbage collected.

At some point, garbage collection may be performed by reinitializing the inference engine at 930 and then adding the valid (non-disabled) clauses back into the inference engine at 940. For initialization, the entries in the BRAM may be written to their initial value (e.g., clear the clauses in an inference engine). Using both BRAM ports, a worst case number of writes can be reduced to half the table size. By targeting inference engines with only a smaller number of valid clauses, the re-insertion overhead may be minimized.

Thus, the BCP part of the SAT solving process may be accelerated in hardware. In an implementation, branching, restarting, and conflict analysis may be left to the software on the host CPU. An example system offloads 80 to 90 percent of the software SAT solver's computation. While this system may be mapped to an FPGA to reduce cost and speed-up development time, the system is also relevant to ASIC designs. The co-processor can load SAT instances in milliseconds, can handle SAT instances with tens of thousands of variables and clauses using a single FPGA, and can scale to handle more clauses by using multiple FPGAs.

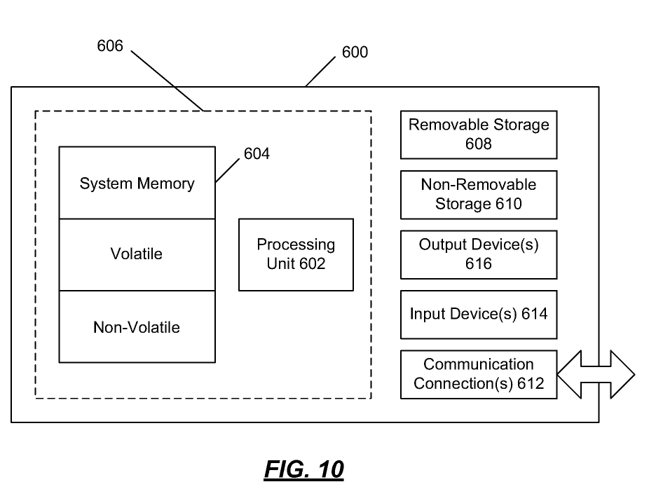

FIG. 10 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that performs particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 10, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as RAM), non-volatile (such as read-only memory (ROM), flash memory, etc.), or some combination of the two. This most basic configuration is illustrated in FIG. 10 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 10 by removable storage 608 and non-removable storage 610.

Computing device 600 typically includes a variety of computer readable media. Computer readable media can be any available media that can be accessed by device 600 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A hardware accelerator for a Boolean satisfiability solver, comprising:
a first inference engine storing a plurality of clauses of a Boolean satisfiability formula;
a second inference engine storing a plurality of learned clauses of the Boolean satisfiability formula; and
an inference multiplexer that serializes a plurality of results from the first and second inference engines.

2. The hardware accelerator of claim 1, wherein the plurality of clauses is a set of non-learned clauses, and the first inference engine only stores the plurality of non-learned clauses.

3. The hardware accelerator of claim 1, wherein at least one of the plurality of clauses stored by the first inference engine is an additional learned clause.

4. The hardware accelerator of claim 1, wherein the second inference engine further stores a non-learned clause.

5. The hardware accelerator of claim 1, wherein the second inference engine is a first learned clause inference engine that only stores the learned clause and additional learned clauses.

6. The hardware accelerator of claim 5, further comprising:
a second learned clause inference engine; and
an implication queue that stores and distributes to the first and second learned clause inference engines in parallel a new learned clause derived from a conflict analysis.

7. The hardware accelerator of claim 6, wherein the first and second learned clause inference engines process the new learned clause in parallel to determine into which of the first or second learned clause inference engine the new learned clause is to be inserted.

8. The hardware accelerator of claim 6, wherein each of the first and second learned clause inference engines comprises a walk table and a clause status table, the walk table comprises index information pertaining to each learned clause and the clause status table comprises values of literals in each learned clause.

9. The hardware accelerator of claim 1, wherein the second inference engine deletes the learned clause by invalidating the learned clause.

10. A method for inserting a clause of a Boolean satisfiability formula into an inference engine, comprising:
providing a learned clause to a plurality of inference engines;
determining which of the inference engines have space available to insert the learned clause;
selecting one of the inference engines that has space available; and
inserting the learned clause in the selected inference engine.

11. The method of claim 10, further comprising:
determining which of the inference engines comprise at least one of the literals of the learned clause; and
excluding the inference engines that comprise at least one of the literals from inserting the learned clause.

12. The method of claim 11, further comprising initiating a garbage collection on at least one of the inference engines when there is no space available to insert the learned clause, the garbage collection comprising reinitializing the at least one of the inference engines and adding a plurality of valid clauses back to the at least one of the inference engines.

13. The method of claim 11, wherein determining which of the inference engines comprise at least one of the literals of the learned clause comprises performing a tree walk technique on a tree walk table associated with each of the inference engines.

14. The method of claim 10, wherein determining which of the inference engines have space available to insert the learned clause is performed in parallel for each of the inference engines.

15. The method of claim 10, further comprising updating a clause status table, a global status table, and a translation table for the inference engine into which the learned clause is inserted.

16. The method of claim 10, wherein each of the inference engines is a learned clause inference engine that only stores a plurality of learned clauses.

17. A method for deleting a clause of a Boolean satisfiability formula from an inference engine, comprising:
receiving a delete clause instruction at the inference engine to delete a learned clause from the inference engine; and
invalidating the learned clause in the inference engine without removing the learned clause from inference engine.

18. The method of claim 17, wherein invalidating the learned clause comprises adding a tag to an entry of the learned clause in a clause status table associated with the inference engine to prevent an implication being generated by the learned clause.

19. The method of claim 17, further comprising removing the learned clause from the inference engine pursuant to the inference engine attempting to insert another learned clause.

20. The method of claim 17, further comprising removing the learned clause from the inference engine after the learned clause has been invalidated by reinitializing the inference engine and adding a plurality of valid clauses back to the inference engine.
